(19) United States
(12) Patent Application Publication
(10) Pub. No.: US 2003/0088553 A1
(43) Pub. Date: May 8, 2003

(54) Method for providing relevant search results based on an initial online search query

(75) Inventor: Dante Monteverde, Barrington Hills, IL (US)

Correspondence Address: SEYFARTH SHAW, 55 EAST MONROE STREET, SUITE 4200, CHICAGO, IL, 60603-5803, US

(73) Assignee: EMERgency 24, Inc., Chicago, IL (US)

(21) Appl. No.: 10/065,834

(22) Filed: Nov. 23, 2002

(51) Int. Cl. G06F 17/30

(52) U.S. Cl. 707/3

(57) ABSTRACT

A method for providing relevant search results based on an initial search query from a searcher utilizing an online search engine. The method generates a return list of relevant results after the searcher executes an initial keyword query through an online search engine. The initial query is matched to a predefined category based on the queried search term's relevancy to the topical category. The most popular category for the search term is then determined based on a set of preponderant criteria. Once the most popular category is determined for the queried search term, the search engine provider implements a set of statistical data that calculates the most popular Internet site(s) by online searchers within the chosen category using various sets of criteria, in order to determine the best Internet site(s) to be displayed in the return list.

### BACKGROUND OF THE INVENTION

The present invention relates generally to the production of Internet search results. More particularly, the present invention relates to generating and retrieving relevant search results based upon an initial search query utilizing a conventional Internet search engine.

In its purest form, a search query is no more than a word or phrase. However, such a simple search query usually results in the retrieval of an overabundance of documents, many of which are generally irrelevant but were retrieved nonetheless. In essence, the success and usefulness of a search query depends on the searcher's skill and knowledge in creating and selecting the most accurate words for the search query, as well as the capability of the search engine in providing relevant documents based upon that search query.

The amount of informational content available on the Internet is and will, in all probability, continue to expand at an exponential rate. This expansion, coupled with the decentralized and anarchistic nature of the Internet, creates considerable difficulty in locating and retrieving particular informational content.

As a result, many existing Internet search providers maintain generalized content based searching. For example, keywords or metatags located in the Internet documents are customarily used wherein the search provider matches the search term with documents containing matching keywords or metatags. However, even when content is found through an existing Internet search provider, a further difficulty occurs in trying to evaluate the relative merit or relevance of the documents that are retrieved. The search for specific documents utilizing only a few keywords will almost always identify documents whose relevancy is uncertain. Thus, the total volume of irrelevant documents retrieved in the return lists tends to weaken the usefulness of the Internet in finding specific informational content.

Internet search providers typically seek out and scan the Internet to create objective indexes of Internet sites that can later be searched in response to a searcher's particular query. In order to be recognized as a valuable document locator within the Internet community, the search provider must be capable of performing full searches of all the available information on the Internet, provide immediate search-query response times, and develop an appropriate system for ranking the documents according to their relevancy, amongst other things.

Once the service provider has indexed individual Internet pages from various Internet sites, the service provider then stores a list of terms, or individual words, that occur or repeat themselves within the indexed pages. In theory, the more frequent certain words appear or repeat within the document, excluding of course simple verbs, prepositions, and conjunctions, the more relevancy those words are given in describing the content of the document. Thus, the greater a certain word appears within an indexed document, the more relevant that document becomes to a searcher who enters that specific word as his or her keyword for a search query.

However, documents posted on the Internet are often posted with little or no editorial supervision. As a result, many documents are overwhelmed with discrepancies and mistakes that decrease the usefulness of a search engine. In addition, because the Internet has become a medium for advertisers, many Internet sites seek to catch the attention of visitors. As a result, promoters of these sites attempt to incorporate undetectable words, which act as an enticement for drawing the attention of search engines relying on its false relevancy.

The unreliability associated with many documents on the Internet poses a serious problem when a search engine tries to rank the relevance of located documents. Typically, all that the search engine has to work with is the distribution of words, and as such, it can do little more than indicate whether or not the distribution of words in a particular document matches the search query more closely than the distribution of words in another document. Furthermore, because there are no standards for relevancy rankings on the Internet, there is no assurance that the highest ranked document returned by a search engine is the most relevant. As such, the uninhibited nature of documents posted on the Internet results in an atmosphere that is not reliably searchable in a well-organized manner by existing search engines.

Some search engines have attempted to rectify this problem by using a combination of criteria and algorithms to determine the rank and relevance of a particular Internet site for any given search term. For example, some search engines consider the number of links or hyperlinks from a particular Internet site A pointing to another Internet site B as a credit for trustworthiness or importance of site B. Thus, the more links pointing to site B the more relevant that site becomes. These search engines also take into account the importance of site A by analyzing how many links are referring to that specific site. Credits cast by Internet sites that are themselves trustworthy are given more weight in determining the ranking of other sites.

However, basing a site's ranking or relevancy on the number of links pointing to or from it is subject to the same type of manipulation as other search engine methodologies. For example, Internet site promoters can purchase or participate in link exchange programs wherein they pay another site to refer back to them, thus undermining the very purpose of using links as a form of legitimacy. Furthermore, because these search engines employ an indexing methodology without discriminating against Internet sites that are not heavily trafficked by Internet searchers, their return lists can contain millions of Internet sites, which is impossible for the searcher to comprehend.

The present invention overcomes the disadvantages and/or shortcomings of known prior art online search engines and provides significant improvements thereover.

### BRIEF SUMMARY OF THE INVENTION

It is therefore an object of the present invention to provide a method for reliably providing relevant search results to a searcher after submitting an initial search query.

It is yet another object of the present invention to provide the searcher with the most popular category(ies) for an initial keyword query.

A further object of the present invention is to provide the searcher with the most relevant Internet sites based on statistical analysis that tracks the number of times searchers visit a particular Internet site, thus enhancing each Internet site's popularity.

Another object of the present invention is to limit the amount of Internet sites that are returned on the return list to a manageable number for the searcher to review.

Still a further object of the present invention is to track searcher activities when utilizing the service provider's search engine to determine which Internet sites are visited most within a given category and implement that data into an evolving system that will update the database and provide the searcher's with the most relevant Internet site(s) for any given search term based upon prior results.

The present invention is a unique and novel process for conducting Internet based document searches through an Internet search engine by providing a method for reliably and efficiently supplying relevant Internet sites based on an initial keyword query.

In an embodiment of the present invention, a searcher enters at least one keyword into a conventional search engine input box. Once the searcher submits the initial search query, the present invention produces a list of relevant Internet sites based upon that initial search term.

An embodiment of the present invention maintains at least one database containing predefined categories. Each category contained in this database is created, defined and maintained by a search engine provider or other 3rd party. Once the categories are defined, anticipated search terms provided in a search term database are matched to at least one of the categories based on the search term's definitional relevancy and/or linguistic usage compared to the category. A third database providing Internet site information, such as hyperlink, title, or content, is used wherein each Internet site is matched to at least one of the predefined categories based upon either an objective or subjective approximated relationship between the content of the documents and/or the predefined descriptions of each respective category.

Once the searcher submits an initial search query, only the most popular category out of all the categories that the search term may belong to is provided by implementing a set of preponderance criteria that, amongst other means, calculates the number of times a particular category is selected by prior searchers in association with each respective search term used in the initial search, uses subjective determinations made by the search engine provider as to which search terms belong to which categories, and/or calculates the number of times a search term is repeated within the pre-designated keywords contained within Internet sites associated with the category.

After the searcher submits his or her initial query, a search result list comprising Internet sites belonging to the most popular category is displayed, preferably arranged by relevancy and popularity.

### BRIEF DESCRIPTION OF THE SEVERAL VIEWS OF THE DRAWINGS

The preferred embodiment is herein described in detail with references to the drawings, where appropriate, wherein:

FIG. 1 is a flowchart depicting the preferred embodiment's method of categorizing Internet sites contained within the Internet site database;

FIG. 2 is a flowchart depicting an existing typical Internet search result retrieval system;

FIG. 3 is a flowchart depicting the preferred embodiment's method of selecting the most relevant Internet sites for any given keyword query;

FIG. 4 is a flowchart depicting the preferred embodiment's method of determining the most relevant category;

FIG. 5 is a flowchart depicting the preferred embodiment's method of determining the most relevant Internet sites for each category; and

FIG. 6 is an example of a specific embodiment of the present invention.

### DETAILED DESCRIPTION OF THE INVENTION

The preferred embodiment of the present invention is a unique and novel process for conducting Internet based document searches through an Internet search engine by providing a method for reliably and efficiently supplying relevant Internet sites based on an initial keyword query. The present invention utilizes a method of assigning search terms and Internet sites to common, pre-defined topical categories in order to accurately and reliably provide the most relevant Internet information available for any given search query.

The topical categories are preferably defined with a title and a description, somewhat similar to encyclopedic topics and are provided in a topical category database. Alternately, the topical categories can be defined with other cataloging references, such as a numeric cataloging system, computer cataloging system, and the like.

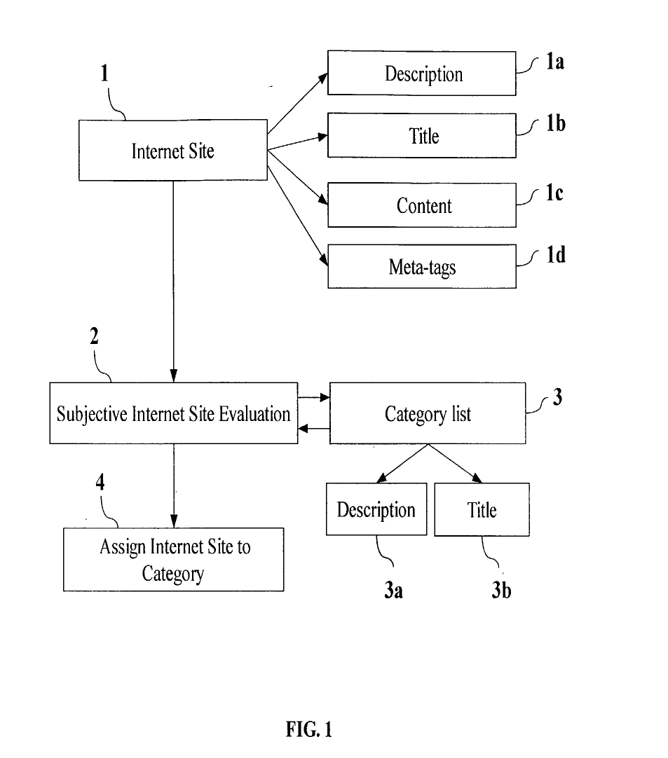

The preferred embodiment of the present invention provides an Internet site database with information for at least one Internet site. Preferably, the Internet site database contains information relative to each respective Internet site, such as topic, title, content, author, description, and its uniform resource locator. Referring to FIG. 1, the preferred embodiment of the present invention utilizes a subjective determination to systematically assign each Internet site 1 contained within the Internet site database to at least one pre-defined topical category in the topical category database utilizing a preferred method wherein the Internet site 1 is dissected into 4 subparts; a description 1a, a title 1b, content 1c, and meta-tags 1d. The subparts are used by the search engine service provider to evaluate the Internet site 2 and compare the components of the Internet site to each topical category contained within the topical category database to assign each Internet site to an appropriate topical category(ies) 4. Alternately, the present invention can categorize the Internet site 1 utilizing any combination of the Internet site's 1 description 1a, title 1b, content 1c, or meta-tags 1d. Still alternately, a Internet site can be assigned to a pre-defined topical category by using any sub-part exclusively. In any event, each Internet site 1 is assigned to at least one topical category.

The preferred embodiment of the present invention also provides a search term database having at least one search term. The search terms contained within the search term database are also assigned to at least one of the pre-defined topical categories contained within the topical category database, based upon their respective definitions and/or common language usages, thus creating a search term assignment. As such, search terms and Internet sites are assigned to common pre-defined topical categories contained within the same topical category database.

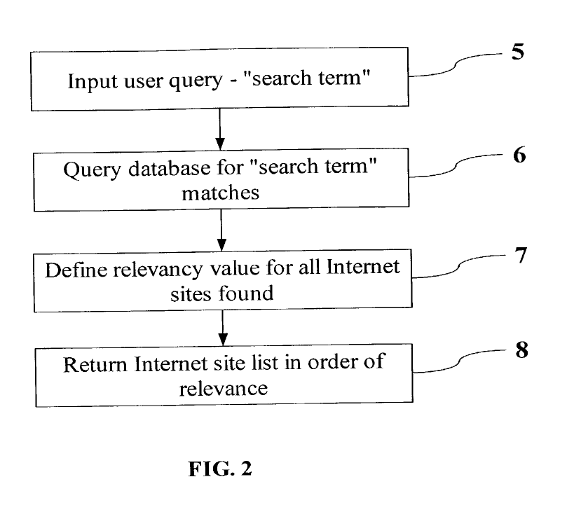

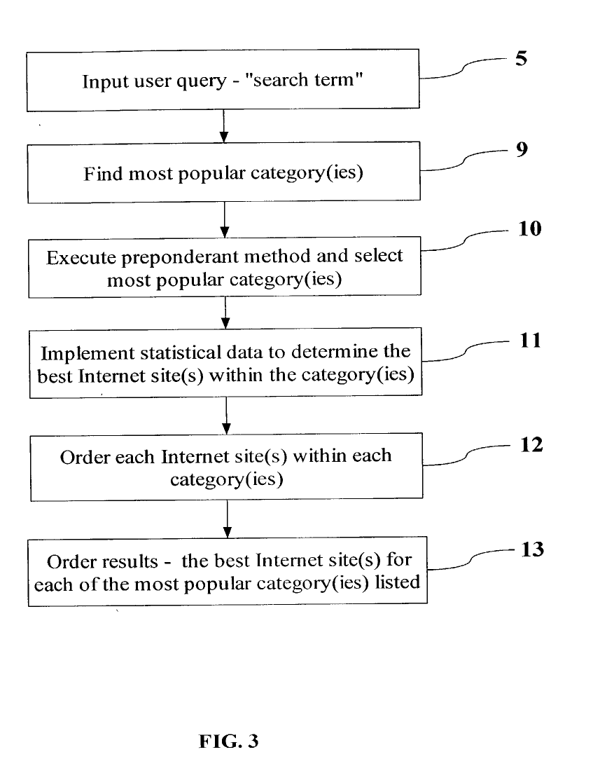

Referring to FIGS. 2 and 3, the preferred embodiment of the present invention begins when a searcher sends at least one initial search term 5 via a conventional search term input box. The initial search term preferably contains at least one word the searcher desires to search. Alternately, the initial search term can contain a string of words. After receiving the initial search term, the present invention finds the most popular topical category(ies) 9 for that initial search term. This step is initiated by accessing the search term database, matching the initial search term to a corresponding search term within the search term database, and associating the initial search term with the pre-defined topical category(ies) assigned to the matched search term within the search term database.

If more than one pre-defined category is assigned to the initial search term, then the preferred embodiment of the present invention utilizes a preponderant method 10 and determines the most popular topical category for that initial search term.

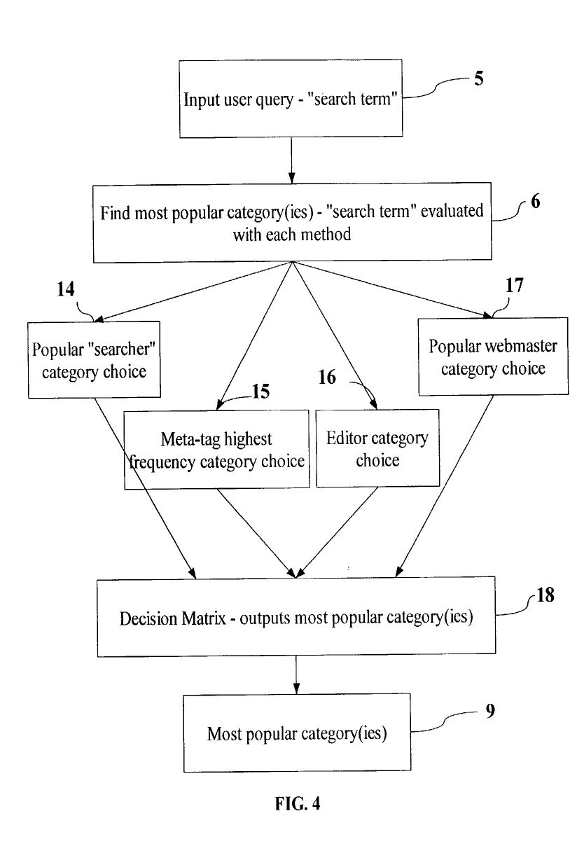

Referring to FIG. 4, the preponderant method preferably determines the most popular topical category 9, either in combination or exclusivity, by calculating the number of times a particular topical category is selected by other searchers in association with each respective search term used in the initial search query, termed popular “searcher” category choice 14; calculating the number of times a search term is repeated within the contents of each Internet site assigned with the topical category termed highest frequency category choice 15; a subjective determination made by the search service provider who automatically assigns a most popular category 16; or a subjective determination made by the Internet site's author as to which topical category should be deemed the most popular category for this Internet site.

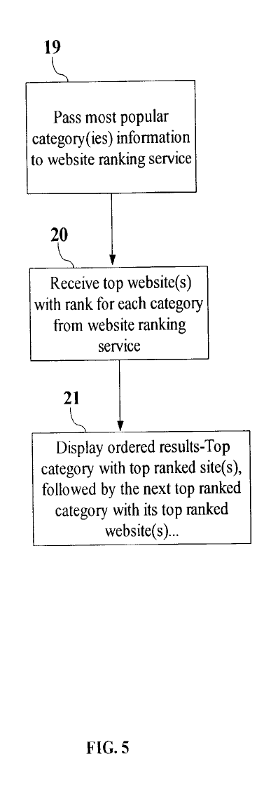

Referring to FIGS. 4 and 5, once the preponderant method determines the most popular topical category, the present invention may utilize statistical market research data to determine the most popular Internet sites assigned to that particular most popular topical category. The service provider may disclose the most popular topical category information with the statistical data provider 19 so that the Internet site information gets assigned to the proper topical category. As such, the present invention may track searcher activities when utilizing the service provider's search engine to determine which Internet sites are visited most within any given topical category and implement that data into an evolving system that will update the topical category database and provide the searchers with the most relevant Internet site(s) for any given search term based upon prior results. Once this statistical information is received by the statistical data provider, the Internet sites may then be organized based on a number of criteria including, but not limited to, the number of unique visitors to each Internet site, the total amount of traffic to the Internet site, the number of hyperlinks pointing to the Internet site, and any other data used to assess the popularity of the Internet site. Once the Internet site(s) are organized for that particular topical category, the most popular topical category is displayed along with its correspondingly assigned Internet site(s) information, followed by the next most popular category with its correspondingly assigned Internet site information in the same fashion as stated above, and so on. Preferably, the most popular topical category search results are listed first by listing all Internet sites' information assigned to that specific most popular topical category and organized with the statistical information. It is anticipated that the most popular topical category assigned to the initial search result will contain the information that the searcher was initially searching for.

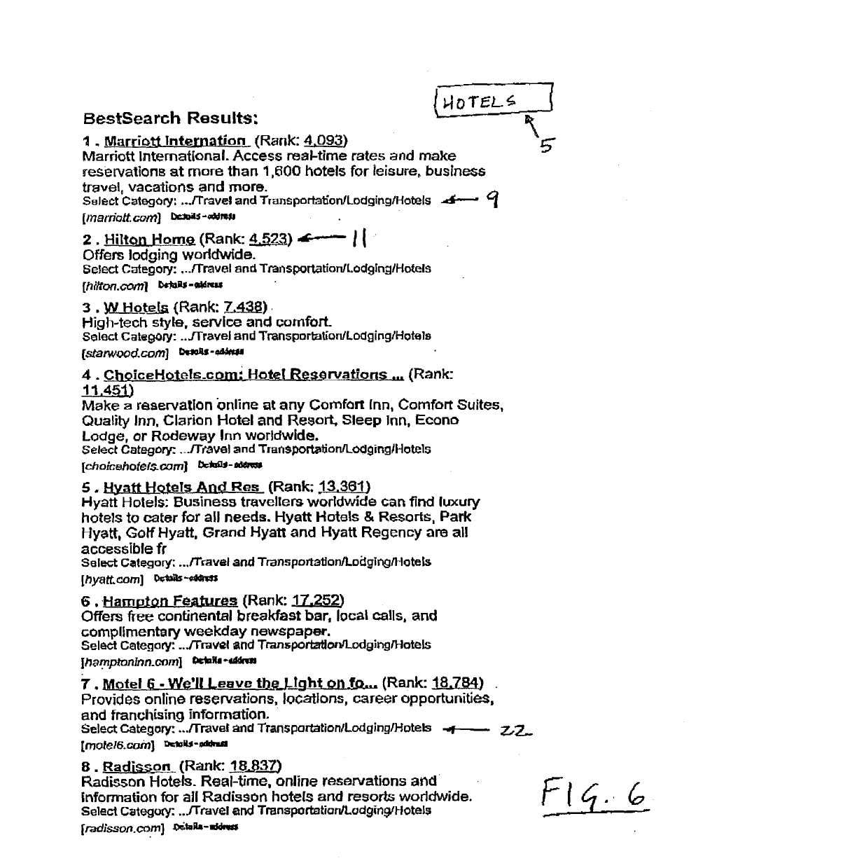

The present invention can be better illustrated with the following example, which is intended to explain, and not limit, the invention. Referring to FIG. 6, an example embodiment of the present invention reflecting the use of the present invention in an Internet search engine setting, where a searcher enters an initial search term 5 “hotels” in the search input box, submits the search to the search engine provider, and a return list is displayed showing the most popular topical category 9 and its correspondingly assigned Internet site information with statistical popularity data 11. Following the most popular topical category 9 is the second most popular category 22 for the term “hotels” with its correspondingly assigned Internet site information.

While preferred and alternate embodiments have been described herein, it is to be understood that these descriptions are only illustrative and are thus exemplifications of the present invention and shall not be construed as limiting. It is to be expected that others will contemplate differences, which, while different from the foregoing description, do not depart from the true spirit and scope of the present invention herein described and claimed.

What is claimed is:

1. A method of determining relevant search results for an Internet based search query having at least one search term, the method comprising the steps of:
providing a topical category database having a plurality of topical categories;
providing an Internet site database having Internet site information for at least one Internet site, each of the Internet sites having content;
assigning each of the Internet site informations in the Internet site database to at least one of the topical categories in the topical category database thereby creating assigned Internet sites;
providing a search term database having at least one search term, each of the search terms having a definition;
assigning each of the search terms in the search term database to at least one of the topical categories in the topical category database thereby creating a search term assignment;
receiving at least one initial search term;
matching the initial search term with at least one of the search terms in the search term database thereby creating a matched search term;
associating the initial search term with the topical categories that the matched search term is assigned to thereby creating associated topical categories;
determining a most relevant associated topical category from the associated topical categories; and
retrieving the Internet site information for each of the assigned Internet sites assigned to the most relevant associated topical category.

2. The method as claimed in claim 1 wherein each of the topical categories is defined with a title and description.

3. The method as claimed in claim 1 wherein the step of assigning each of the search terms in the search term database to at least one of the topical categories in the topical category database thereby creating a search term assignment comprises assigning each of the search terms to a topical category based on the definition.

4. The method as claimed in claim 1 wherein the step of determining a most relevant associated topical category from the associated topical categories comprises calculating the number of times each said associated topical category is selected by other searchers in association with the initial search term.

5. The method as claimed in claim 1 wherein the step of determining a most relevant associated topical category from the associated topical categories comprises calculating the number of times the search term is repeated within the content of the assigned Internet sites assigned to each of the associated topical categories.

6. The method as claimed in claim 1 wherein the step of determining a most relevant associated topical category from the associated topical categories comprises subjectively determining the most relevant associated topical category.

7. The method as claimed in claim 1 wherein the step of retrieving the Internet site information for each assigned Internet site assigned to the most relevant associated topical category comprises the step of organizing the assigned Internet sites in a logistical order.

8. The method as claimed in claim 8 wherein the step of organizing the assigned Internet sites in a logistical order further comprises organizing the assigned Internet sites based upon statistical information.
